(19) United States
(12) Patent Application Publication
(10) Pub. No.: US 2006/0136304 A1
(43) Pub. Date: Jun. 22, 2006

(54) Connection method of placing and receiving an order for mold machining through a web-based system for real-time utilization of idle facilities for molds

(75) Inventors: Baeg Soon Cha, Bucheon City (KR); Yong Ju Cho, Seoul (KR)

Correspondence Address: GREENBLUM & BERNSTEIN, P.L.C., 1950 ROLAND CLARKE PLACE, RESTON, VA, 20191, US

(73) Assignee: Korea Institute of Industrial Technology, Chonan-si (KR)

(21) Appl. No.: 11/091,628

(22) Filed: Mar. 29, 2005

(30) Foreign Application Priority Data
Dec. 21, 2004 (KR) 10-2004-0109664

(51) Int. Cl. G06Q 30/00

(52) U.S. Cl. 705/26

(57) ABSTRACT

Disclosed is a connection method of placing and receiving an order for mold machining through the web-based system for real-time utilization of idle facilities for mold, comprising: entering information relating to holding facilities held by the subcontractors for mold machining in database, wherein the subcontractors are members entering the information and receiving an order for mold machining; and searching the database for the information relating to holding facilities, wherein the mold manufacturers are members searching the information and placing an order for mold machining; wherein the subcontractors enter idle time period of idle facilities of the holding facilities in database and the mold manufacturers regard the idle facilities for the idle time period as the facilities held by the mold manufacturers, whereby ERP scheduling is possible.

### BACKGROUND OF THE INVENTION

1. Field of the Invention

The present invention relates to a connection method of placing and receiving an order for mold machining through a web-based system for real-time utilization of idle facilities for mold, and, more particularly, to a connection method of placing and receiving an order for mold machining, by which it is possible for mold manufacturers to regard idle facilities held by subcontractors for mold machining as their own holding facilities so that ERP(Enterprise Resource Planning) scheduling can be achieved.

2. Description of the Prior Art

As generally known in the art of mold, mold designers who receive particulars and specification from product developers forward mold manufacturers the specification and design of mold to request mold manufacturing, and the mold manufacturers have subcontractors carry out much of the mold manufacturing.

Conventionally, it took the mold manufacturers a lot of time to seek the subcontractors who hold the facilities with which the mold to be manufactured can be machined. Also, the subcontractors, to raise the working ratio of their own holding facilities, spent much time seeking mold manufacturers to request the mold machining.

Recently, the Internet has widely been used, and thus, on-line information providers who connect the mold manufacturers with the subcontractors for mold machining has come into being. However, these on-line information providers mainly sell products and only incidentally connect between placing and receiving an order for mold machining through simple board. Therefore, information relating to an order for mold machining has been exchanged between the mold manufacturers and the subcontractors by the off-line contact through a telephone, a visit, etc., so the same time as in the conventional method of placing and receiving an order has been spent.

Further, since information relating to holding facilities held by the subcontractors, which is entered in database of the on-line information providers, is insufficient and not systematic, and it is not easy for the mold manufacturers to search the database for the required information, the on-line connection between placing and receiving an order for mold machining has not been widely used.

Also, it is not preferred from the viewpoint of product developers that much time is spent on manufacturing the mold, since, if products are not timely produced, the development costs increase, the marketability decreases, products of competitors prevail, the increase rate of sale becomes lower, and, finally, profits are extremely decreased.

### SUMMARY OF THE INVENTION

Accordingly, the present invention has been made to solve the above-mentioned problems in the prior art, and an object of the present invention is to provide the essential and systematic information relating to holding facilities, particularly, idle facilities held by the subcontractors so that the mold manufacturers are capable of ERP scheduling.

In order to achieve the above, according to the first aspect of the present invention, there is provided a connection method of placing and receiving an order for mold machining through the web-based system for real-time utilization of idle facilities for mold, comprising: entering information relating to holding facilities held by the subcontractors for mold machining in database, wherein the subcontractors are members entering the information and receiving an order for mold machining; and searching the database for the information relating to holding facilities, wherein the mold manufacturers are members searching the information and placing an order for mold machining; wherein the subcontractors enter idle time period of idle facilities of the holding facilities in database and the mold manufacturers regard the idle facilities for the idle time period as the facilities held by the mold manufacturers, whereby ERP scheduling is possible.

ERP is required for efficient disposition and assessment of resources such as facilities, etc., required for the mold manufacturers to manufacture the mold, in which it is necessary that flow of all the resources required to manufacture the mold is extracted exactly.

In accordance with the above constitution, the connection between placing and receiving an order for mold machining is carried out efficiently by providing idle time period information of idle facilities held by subcontractors for mold machining in addition to simple information such as contacts, holding facilities, etc., and, therefore, it is possible for the mold manufacturers to regard the idle facilities for the idle time period, which are capable of machining their molds and are held by the subcontractors, as their own holding facilities so that they can achieve ERP scheduling.

In the second aspect of the present invention to achieve the above object, there is provided a connection method according to the first aspect of the present invention, wherein information relating to the idle facilities may be exported from the database into a file in a given format.

The web-based system implementing the present method of the above constitution enables the mold manufacturers to export the information relating to desired idle facilities such as the idle time period, etc., from the database into a file in a given format, for example, when they search the database for the desired idle facilities.

As a result, more efficient ERP scheduling is achieved, since the mold manufacturers don't need to manually enter the desired information in a file of which the format is available to a given software program they wish to use.

In the third aspect of the present invention to achieve the above object, there is provided a connection method according to the second aspect of the present invention, wherein information relating to the idle facilities may be imported from a file in the given format into the database.

The web-based system implementing the present method of the above constitution enables, for example, the subcontractors for mold machining to import the information relating to idle facilities such as the idle time period, etc., from a file in a given format into the database.

As a result, more efficient system is achieved, since the subcontractors don't need to manually enter the information in the database.

In the fourth aspect of the present invention to achieve the above object, there is provided a connection method according to any one of the above present inventions, wherein entering the information relating to the holding facilities in the database and searching the database for the information relating to the holding facilities are carried out based on the facilities classification and specification indicated in FIG. 5 to FIG. 12.

In the web-based system implementing the present method of the above constitution, it is possible to sufficiently provide the mold manufacturers with systematic information required for ERP scheduling, since the respective characteristic specifications of various facilities as indicated in FIG. 5 to FIG. 12 are entered in real-time in the database.

In the fifth aspect of the present invention, there is provided a connection method according to the fourth aspect of the present invention, wherein UML(Unified Modeling Language) modeling is utilized.

Here, UML is a type of modeling language, by which it is possible to design a reliable system since the system may be apprehended and be tuned in the various points of view through Use Case, etc.

The web-based system or program implementing a connection method of placing and receiving an order for mold machining according to the present invention are reliable, since they are designed using the UML.

### BRIEF DESCRIPTION OF THE DRAWINGS

The above and other objects, features and advantages of the present invention will be more apparent from the following detailed description when considered in conjunction with the accompanying drawings, in which:

FIG. 1 is a Use-Case diagram in accordance with the present invention;

FIG. 2 illustrates a display for entering idle time period in accordance with the present invention;

FIG. 3 illustrates a display for searching for idle facilities in accordance with the present invention;

FIG. 4 illustrates a display for administrator in accordance with the present invention; and

FIG. 5 to FIG. 12 illustrate a classification of facilities and specifications of the respective facilities.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

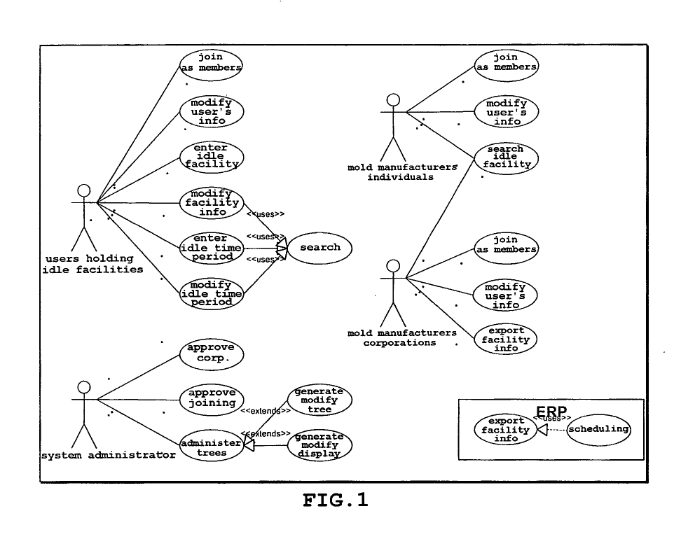

FIG. 1 is a Use-Case diagram, in which a connection method of placing and receiving an order for mold machining is shown from the respective viewpoints of subcontractors holding idle facilities, mold manufacturers and system administrator.

The subcontractors holding the idle facilities are members receiving an order for mold machining through the web-based system implementing a connection method of placing and receiving an order for mold machining according to the present invention, and enter the information such as contacts, holding facilities, idle facilities, idle time period and the like in database of the web-based system on real-time.

The mold manufacturers are members placing an order for mold machining through the web-based system implementing the present connection method, and enter the contact information, etc. in the database of the web-based system.

Through the web-based system, the mold manufacturers search the database for the information of the desired facilities entered by the subcontractors.

In the present connection method, the members of the mold manufacturers may be classified into individuals and corporations as needed, and the corporations may also use the present web-based system only after an approval of a given organization has been made.

The system administrator may be the given organization providing the present connection system and also be the controller only responsible for controlling the system.

As understood from the Use-Case diagram, the web-based system implementing the real-time connection method of the present invention enables the mold manufacturers to export the information relating to the idle facilities and the like from the database into a file in a given format which is compatible with a given software program they wish to use, and, therefore, ERP scheduling of mold manufacture is facilitated.

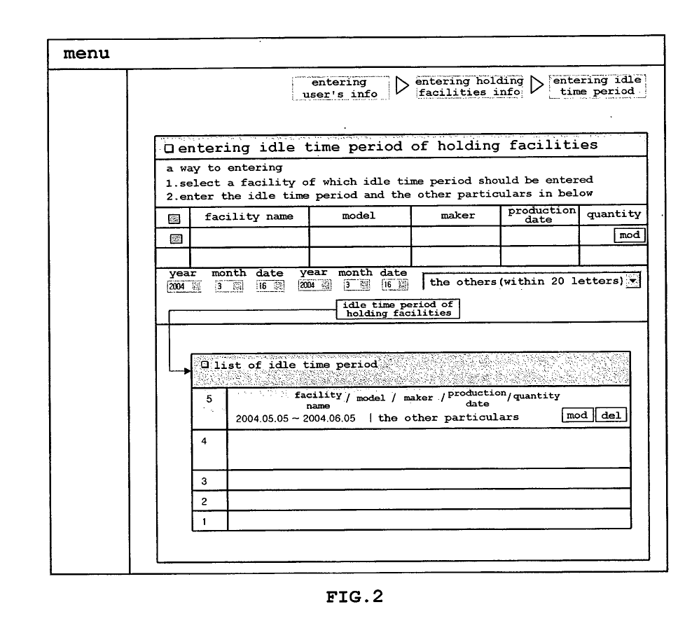

FIG. 2 illustrates a display for entering the idle time period in accordance with the present invention.

In addition to name, model name, maker, date of production, quantity and the like of the respective holding facilities, the subcontractors have to enter idle time period during which the holding facility is idle, and, in the present embodiment, the idle time period is indicated as the start date and expiration date of the idle.

This idle time period entered by the subcontractors is a requisite for the mold manufacturers' ERP scheduling without the additional off-line contact.

While not shown, it is preferred that the display in the present web-based system is provided with an IMPORT button by which, for example, the subcontractors may directly import the information of the idle facilities and the like from a file in a given format into the database of the system without manual entry.

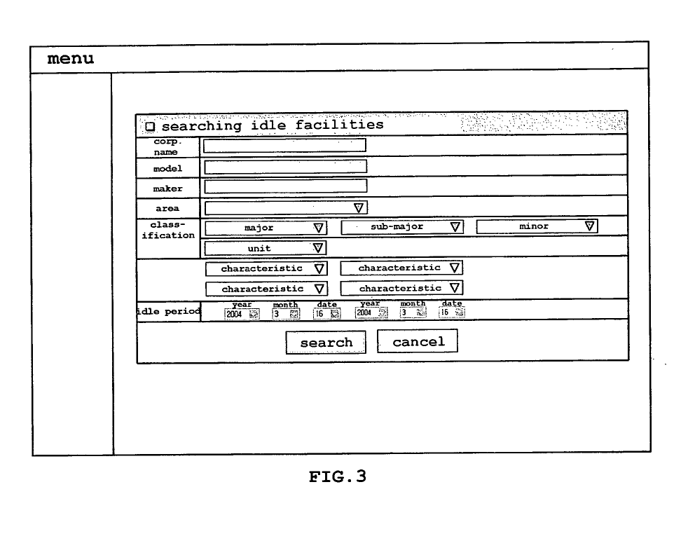

FIG. 3 illustrates a display for searching for the idle facilities in accordance with the present invention.

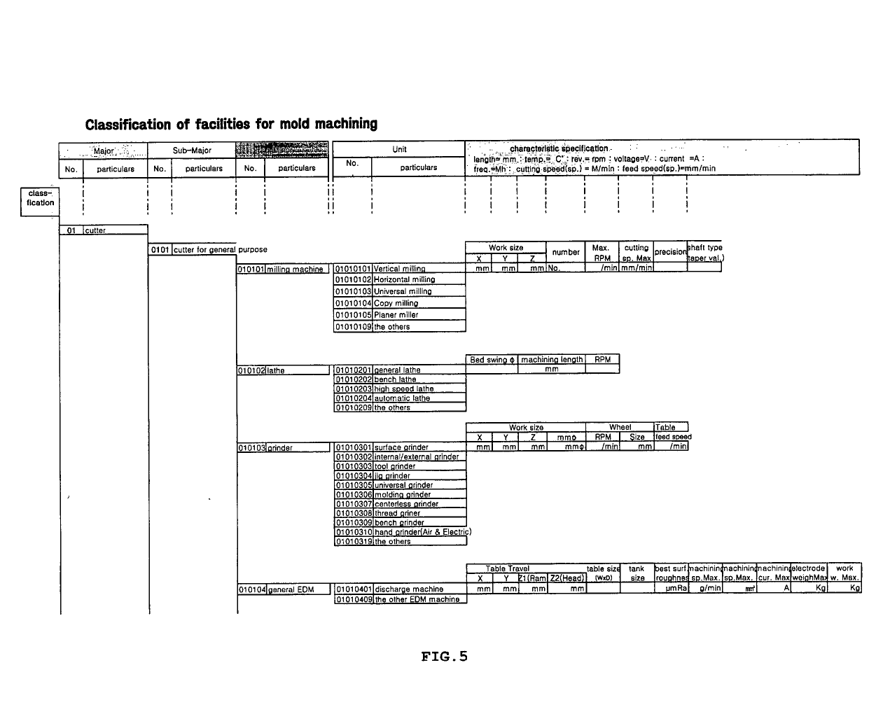

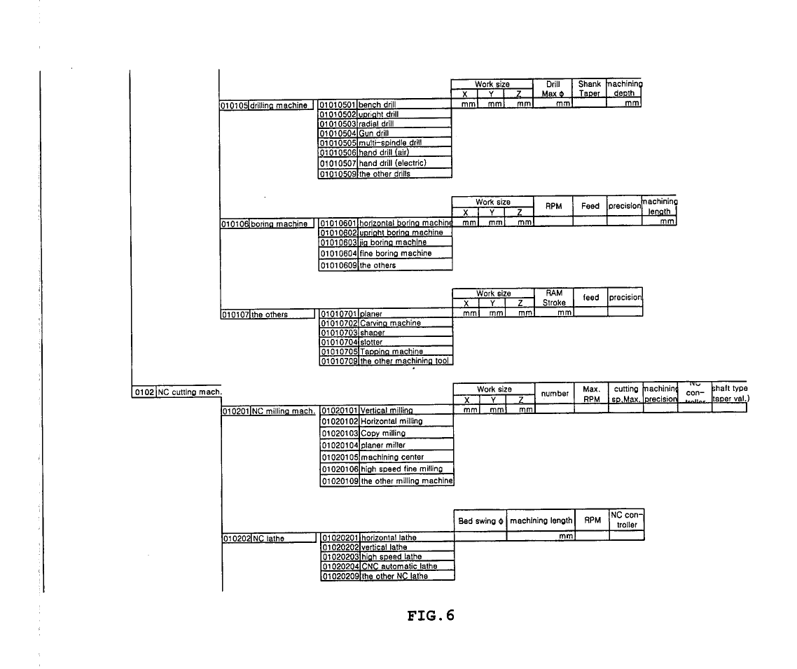

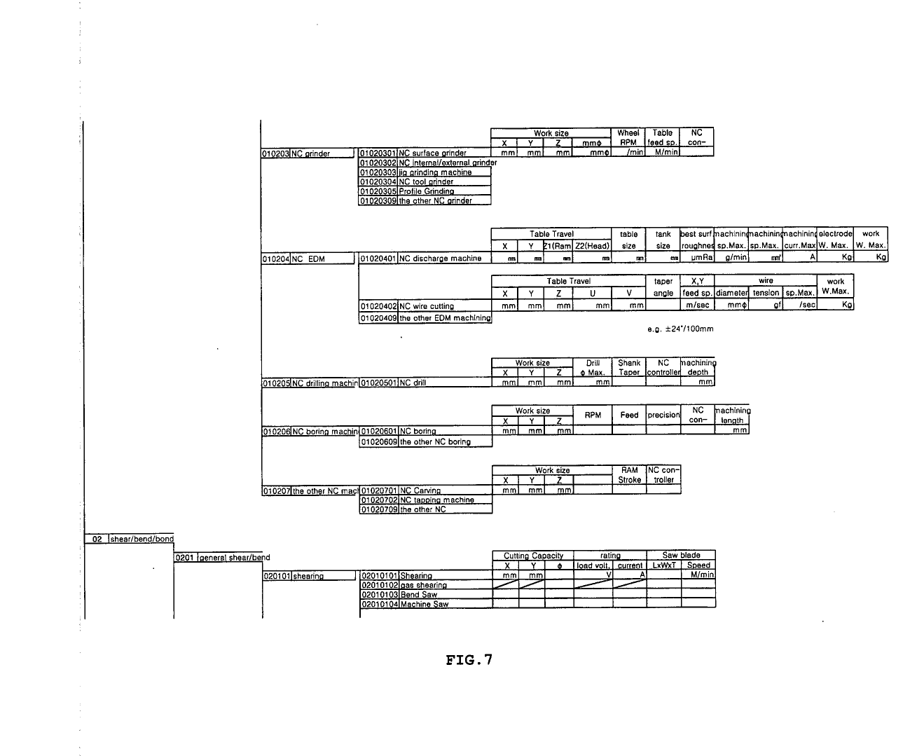

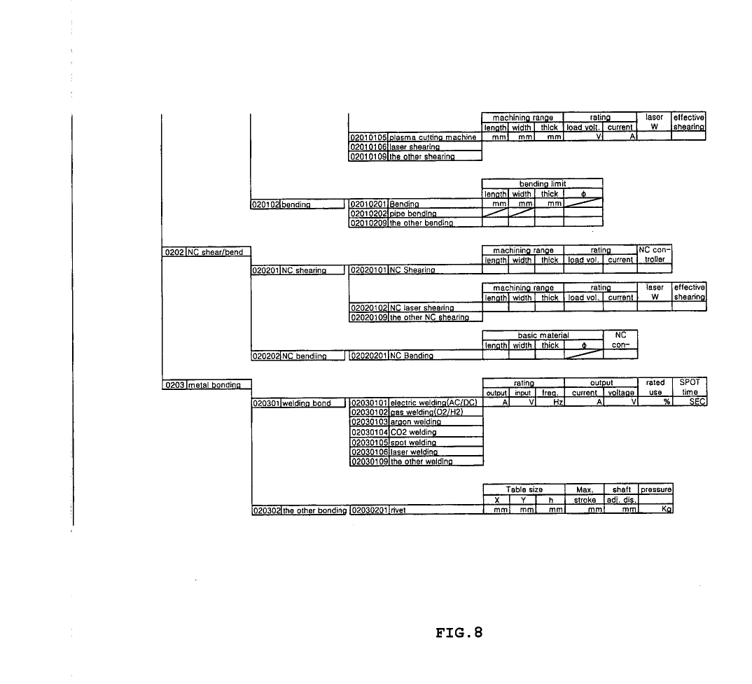

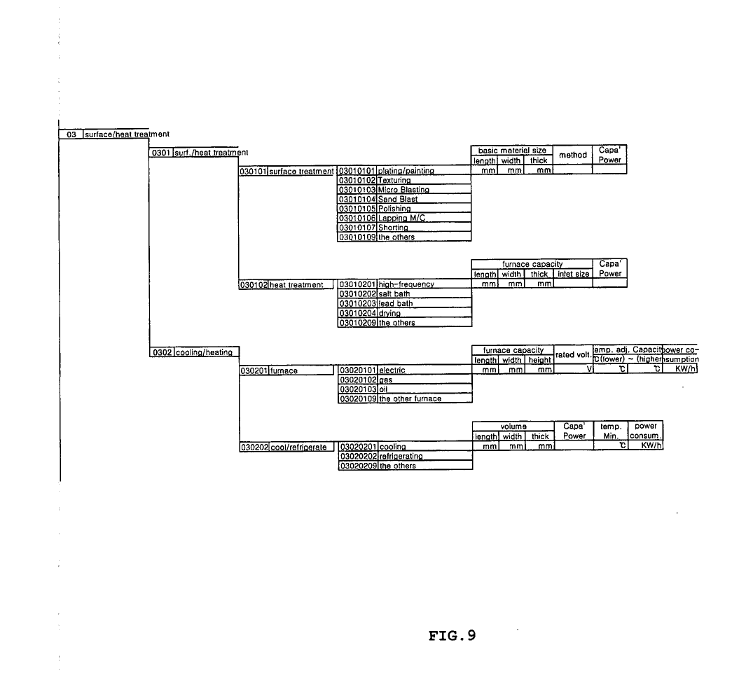

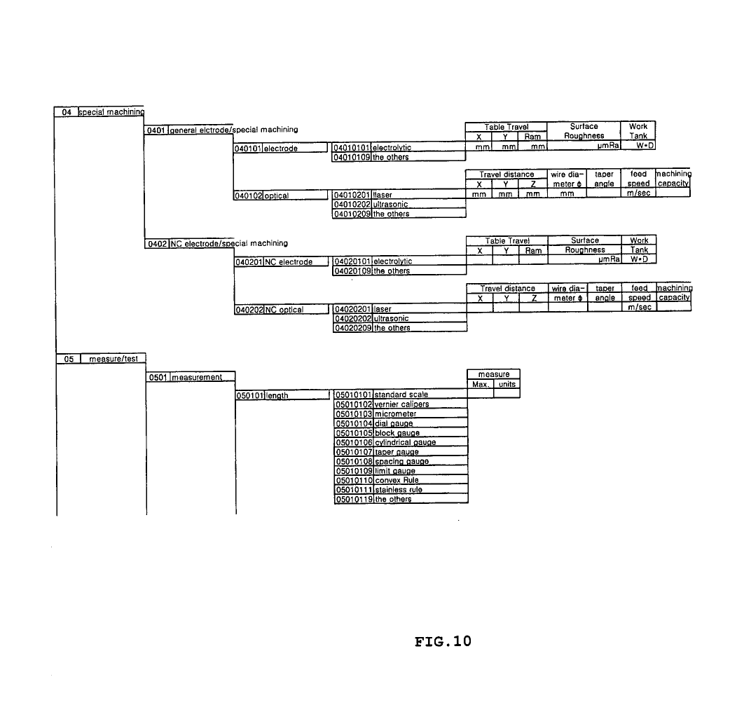

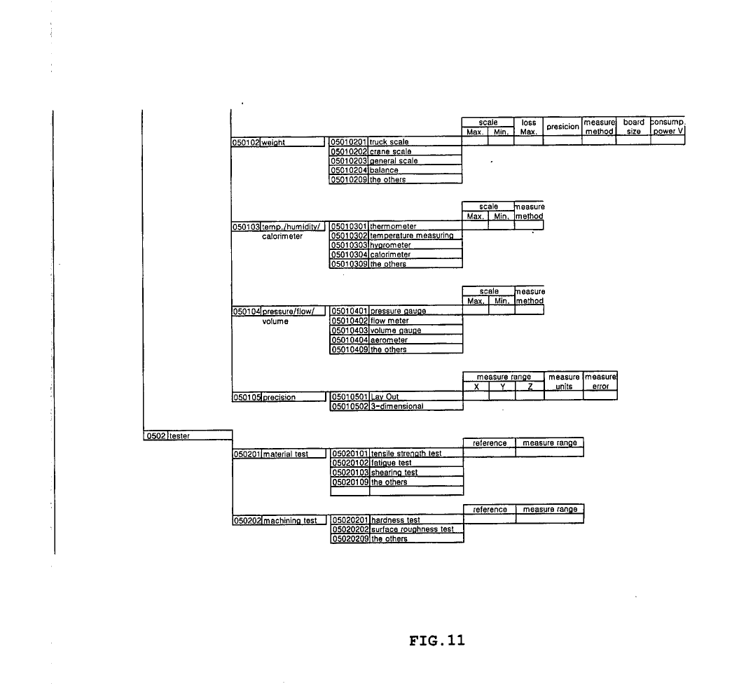

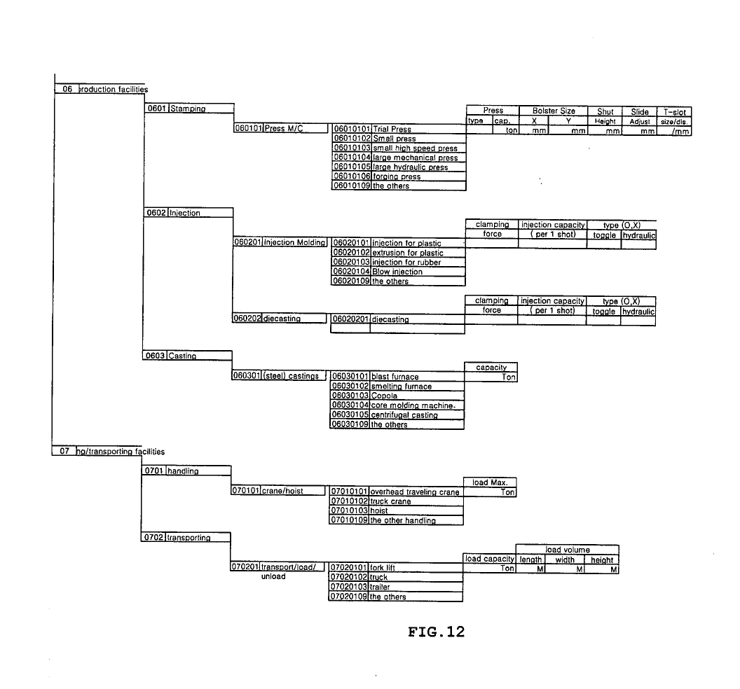

There are various items of corporation names, model names, makers, areas, classifications of facilities, idle time periods and the like, so a search of the various items may be carried out. In the classification item, machining facilities may be selected from classifications as indicated in FIG. 5 to FIG. 12, and the value of characteristic specifications, as indicated in FIG. 5 to FIG. 12, of the selected facility may be selected as desired.

For example, a mold manufacturer may, to search for the desired idle facilities, select “cutter” in major group, “cutter for general purpose” in sub-major, “milling machine” in minor and “universal milling machine” in unit, sequentially. In this case, for example, the value of “work size” may be selected in the first item of characteristic specification with respect to the finally selected “universal milling machine”, the value of “number” may be selected in the second item and the value of “maximum RPM” may be selected in the third item.

Namely, according to the present connection method between placing and receiving an order for mold machining, efficient ERP scheduling may be achieved, and therefore, the connection between the orders for mold machining may be widely used since the subcontractors for mold machining are required to enter the proper characteristics of specification besides the general details with regard to the respective facilities so that the suitable search for the respective facilities may be achieved by entering and searching based on the classification and the characteristic specification indicated in FIG. 5 to FIG. 12 when the subcontractors enter the information relating to their holding facilities in the database of the present system and when the mold manufacturers searches the database for the information relating to the facilities such as the idle and the like held by the subcontractors.

While not shown, it is preferred that the display in the present web-based system is provided with an EXPORT button by which, for example, the mold manufacturers may directly export the information such as the idle time period, etc. relating to the idle facilities and the like held by the subcontractors from the database of the system into a file in a given format which is available to a given software program the manufacturers wish to use.

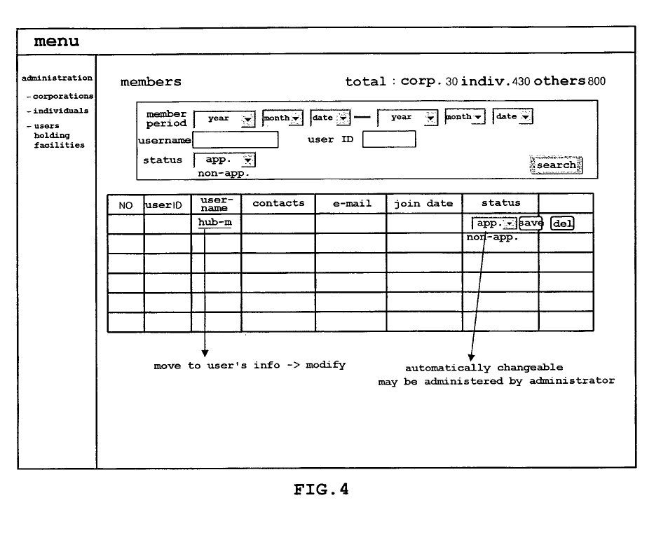

A display for an administrator in accordance with the present invention is illustrated in FIG. 4, in which the administrator may determine whether users, for example, mold manufacturers to use the present system should be approved or not, and may also modify information of users such as the mold manufacturers, subcontractors and the like, as needed.

The description of general portions other than the above-mentioned feature in the present invention, such as joining procedures for on-line members, modifying and deleting information, user's essential or optional entered information (user's ID, password, name, business registration number, representative name, type of company, homepage address, e-mail address, telephone number, facsimile number, business status, business item, sales, capital, number of employees, establishment date, the number of designers, number of workers, holding technology, customers, quality certification, company presentation, business field, person in charge, etc.), on-line contract procedures for mold machining (it is similar to on-line procedures for the sale and purchase of goods) and the like, will be omitted.

As described above, since the present connection method of placing and receiving orders for mold machining provides the essential and systematic information relating to the facilities held by the subcontractors, the mold manufactures are able to easily achieve ERP scheduling and the on-line contract for mold machining may be achieved based on this reliable real-time information.

Although a preferred embodiment of the present invention has been described for illustrative purposes, those skilled in the art will appreciate that various modifications, additions and substitutions are possible, without departing from the scope and spirit of the invention as disclosed in the accompanying claims.

For example, the present connection method may be implemented on the Internet page and may also be implemented on software program which is connected with the database and runs on the respective computers of the users.

1. A connection method of placing and receiving an order for mold machining through a web-based system for real-time utilization of idle facilities for molding, the method comprising:
entering information relating to molding facilities held by the subcontractors for mold machining in a database, wherein the subcontractors are members entering the information and receiving an order for mold machining; and
searching the database for the information relating to molding facilities, wherein the mold manufacturers are members searching the information and placing an order for mold machining;
wherein the subcontractors enter idle time period of idle facilities of the molding facilities in the database and the mold manufacturers regard the idle facilities for the idle time period as the facilities held by the mold manufacturers, whereby ERP scheduling is performable.

2. The connection method according to claim 1, wherein information relating to the idle facilities is configured to be exported from the database into a file in a given format.

3. The connection method according to claim 2, wherein information relating to the idle facilities is configured to be imported from a file in the given format into the database.

4. The connection method according to claim 1, wherein entering the information relating to the molding facilities in the database and searching the database for the information relating to the molding facilities are carried out based on facilities classification and specification indicated in FIG. 5 to FIG. 12.

5. The connection method according to claim 2, wherein entering the information relating to the molding facilities in the database and searching the database for the information relating to the molding facilities are carried out based on facilities classification and specification indicated in FIG. 5 to FIG. 12.

6. The connection method according to claim 3, wherein entering the information relating to the molding facilities in the database and searching the database for the information relating to the molding facilities are carried out based on facilities classification and specification indicated in FIG. 5 to FIG. 12.

7. The connection method according to claim 4, further comprising UML modeling.

8. The connection method according to claim 1, wherein entering the information relating to the molding facilities in the database and searching the database for the information relating to the molding facilities are carried out based on facilities classification data and specification data.

9. The connection method according to claim 2, wherein entering the information relating to the molding facilities in the database and searching the database for the information relating to the molding facilities are carried out based on facilities classification data and specification data.

10. The connection method according to claim 3, wherein entering the information relating to the molding facilities in the database and searching the database for the information relating to the molding facilities are carried out based on facilities classification data and specification data.
